(19) United States
(12) Patent Application Publication
(10) Pub. No.: US 2019/0224952 A1
(43) Pub. Date: Jul. 25, 2019

(54) RECYCLABLE PACKAGE MADE FROM CO-EXTRUDED FILM STRUCTURE

(71) Applicant: NOVA Chemicals (International) S.A., Fribourg (CH)

(72) Inventor: Robert Hugh Clare, Cochrane (CA)

(73) Assignee: NOVA Chemicals (International) S.A., Fribourg (CH)

(21) Appl. No.: 16/325,302

(22) PCT Filed: Aug. 24, 2017
(86) PCT No.: PCT/IB2017/055119

§ 371 Date: Feb. 13, 2019

Related U.S. Application Data
(60) Provisional application No. 62/382,310, filed on Sep. 1, 2016.

(51) Int. Cl. B32B 27/32; B32B 27/08; B32B 27/18; B32B 7/02; B32B 27/30; B65D 75/00; B65D 65/40; B32B 1/00

(52) U.S. Cl. CPC B32B 27/32; B32B 2439/70; B32B 27/18; B32B 7/02; B32B 27/306; B65D 75/008; B65D 65/40; B32B 1/00; B32B 2439/46; B32B 2307/31; B32B 2250/05; B32B 2250/246; B32B 2307/40; B32B 2307/7244; B32B 2307/7265; B32B 27/08

(57) ABSTRACT

A recyclable package such as a Stand Up Pouch (SUP) is prepared using a coextruded polyethylene structure having a first surface layer, a first intermediate layer, a second intermediate layer, and a second surface layer which is a sealable layer. The coextruded structure contains two layers of High Density Polyethylene (HDPE) to provide stiffness. The structure also contains a layer of lower density polyethylene. The structure is optionally surface printed. This structure is suitable for preparing packages for a wide variety of flowable foods (including liquids and solids).

### TECHNICAL FIELD

This disclosure relates to a coextruded polyethylene film structure that is suitable for use in the preparation of a stand up pouch.

### BACKGROUND ART

Stand up pouch (“SUP”) packages are in widespread commercial use as packaging for consumer goods. These pouches are attractive to consumers and, when properly designed, make very efficient use of a minimal amount of polymeric material to prepare the package.

Stand up pouches were first produced about 50 years ago. An early design uses a laminate of a layer of PolyEthyleneTerephthalate (“PET”) and a layer of PolyEthylene (“PE”). This type of design is still in commercial use with a typical structure having a thin layer (about 0.5 mils, or 0.012 mm thick) of PET and a thicker layer (about 3 mils or 0.075 mm) of PE. PET has high flexural modulus in comparison to PE (i.e. PET is stiffer) and this provides rigidity to the finished SUP and also helps the “processability” of the film in the machinery that is used to prepare the SUP. However, a problem with this SUP design is that the pouches are too difficult to recycle because of the different materials of construction.

It is known to prepare a “recyclable” SUP that is prepared only with polyethylene. Similarly, many recycling facilities are able to recycle a coextruded film that contains at least 90% PE in the same way as a “pure” PE material. However, these prior art structures typically do not “process” well on conventional machinery to manufacture SUP because, as noted above, a conventional SUP contains a layer of very stiff PET. Poor processability can result in low productivity (i.e. slow manufacturing rates) and/or poor print alignment when the film stretches “out of position” during the manufacture of the SUP.

Thus, there remains a need for recyclable structures for use in SUP which are made of common materials and which provide stiffness and “processability”. Optical properties may also be important in some packages.

For example, high density polyethylene (“HDPE”) provides the stiffness that is required for a stand up pouch structure but the physical properties and optical properties of HDPE (such as haze and gloss) are comparatively poor. In contrast, linear low density polyethylene (“LLDPE”) provides very good physical and optical properties but poor stiffness. The physical and optical properties of Medium Density Polyethylene (“MDPE”) generally fall in between those of HDPE and LLDPE.

### DISCLOSURE OF INVENTION

The present disclosure allows the preparation of a recyclable package such as a SUP that is prepared using at least 90 (especially at least 95) weight % PE (based on the total weight of polymeric material used to prepare the package).

In one embodiment, the present disclosure provides:

a coextruded multilayer film that is suitable for the preparation of a stand up pouch, comprising:

A) a first surface layer comprising a HDPE composition;

B) a first intermediate layer comprising a polyethylene selected from LLDPE and MDPE;

C) a second intermediate layer comprising a HDPE composition; and

D) a second surface layer comprising a sealable polyethylene composition,

wherein the HDPE, MDPE, LLDPE and sealable polyethylene composition collectively form at least 90 weight % of said coextruded multilayer film.

In an embodiment, the present disclosure provides:

a stand up pouch prepared from a coextruded multilayer film, said coextruded multilayer film, comprising:

A) a first surface layer comprising a HDPE composition;

B) a first intermediate layer comprising a polyethylene selected from LLDPE and MDPE;

C) a second intermediate layer comprising a HDPE composition; and

D) a second surface layer comprising a sealable polyethylene composition,

wherein the HDPE, MDPE, LLDPE and sealable polyethylene composition collectively form at least 90 weight % of said coextruded multilayer film.

In an embodiment, the present disclosure provides:

a coextruded structure (multilayer film) that is made from polymeric material; the coextruded structure comprising:

A) a first surface layer comprising an HDPE composition;

B) a first intermediate layer comprising an MDPE composition;

C) a second intermediate layer comprising an HDPE composition; and

D) a second surface layer comprising a sealable polyethylene composition,

wherein the HDPE, MDPE and sealable polyethylene composition collectively form at least 90 weight % of the coextruded structure.

In an embodiment, the present disclosure provides:

a coextruded structure that is made from polymeric material; the coextruded structure comprising:

A) a first surface layer comprising an HDPE composition;

B) a first intermediate layer comprising an MDPE composition;

C) a second intermediate layer comprising an HDPE composition; and

D) a second surface layer comprising a sealable polyethylene composition,

wherein the HDPE, MDPE and sealable polyethylene composition collectively form at least 90 weight % of the coextruded structure; and wherein the second intermediate layer comprises an HDPE blend, the HDPE blend comprising a blend component A and a blend component B, wherein the blend component A has a melt index, I₂ which is at least 10 times higher than the melt index, I₂ of blend component B.

In one embodiment, the polymeric material consists essentially of different types of polyethylene. Suitable types of polyethylene include:

1) High Density Polyethylene (HDPE)—a polyethylene homopolymer or copolymer having a density of from about 0.95 to about 0.97 g/cc;

2) Medium Density Polyethylene (MDPE)—a polyethylene copolymer having a density of from about 0.93 to about 0.95 g/cc;

3) Linear Low Density Polyethylene (LLDPE)—a polyethylene copolymer having a density of from about 0.915 to about 0.93 g/cc; and

4) a sealable polyethylene composition—a sealant polyethylene material that is suitable for the preparation of a heat formed seal, for example a polyethylene selected from 1) a polyethylene copolymer having a density of from about 0.88 to 0.915 g/cc (“VLDPE”) and 2) a high pressure low density polyethylene (“LDPE”)—a polyethylene homopolymer prepared with a free radical initiator in a high pressure process, having a density of from about 0.91 to about 0.93 g/cc; or a polyethylene material that is suitable for the preparation of a peelable seal.

In one embodiment, a very low density polyethylene (VLDPE) is an ethylene copolymer having a density of from about 0.88 to 0.91 g/cc and a melt index, 12, of from about 0.5 to 10 g/cc.

All of the materials described above are well known and commercially available.

HDPE layers provide good rigidity/stiffness.

In an embodiment, the HDPE layers are separated by at least one layer of lower density polyethylene (such as LLDPE or MDPE) and this lower density polyethylene provides impact and puncture resistance. In addition, by separating the layers of rigid HDPE, the overall rigidity and torsional strength of a package (e.g., a SUP) is improved in comparison to a structure that contains an equivalent amount/thickness of HDPE in a single layer—in a manner that might be referred to as an “I beam” effect (by analogy to the steel I beams that are in wide use for the construction of buildings). Thus, the combination of a) the use of specific HDPE layers and b) the specified order of layers provides excellent rigidity in the SUP packages of this invention.

In some embodiments, the coextruded structure of this disclosure is suitable for the preparation of a package for storing food.

In some embodiments, the coextruded structure of this disclosure is suitable for the preparation of a package for storing frozen food.

In some embodiments, the coextruded structure of this disclosure is suitable for the preparation of a Stand Up Pouch (SUP).

SUP packages are well known. They may be prepared from “roll stock” (i.e., a film—or the coextruded structure of this disclosure) using a variety of well-known techniques and machines.

A good review of SUP design and manufacture is provided in U.S. Pat. No. 6,722,106 (Bartel et al.; assigned to Recot, Inc.) and the references contained in that patent.

Stand up pouches are manufactured in many sizes, and may be used to package consumer goods in small quantities (e.g. from about 25 milliliters to 2 liters). The contents of the SUP packages are typically described as being “flowable”—with the term “flowable” being intended to encompass particulate solids (such as candy, nuts, and breakfast cereal); liquids (for example drinks); and pastes/emulsions/purees (such as yogurt and baby foods). In an embodiment, the SUP is designed to allow the contents of the opened package to easily flow from (and/or to be consumed directly from) the SUP. For example, the top of the SUP may be equipped with an integral straw (for drinks) or spout for pastes, emulsions, purees, and the like. Such designs are well-known and one example is disclosed in Canadian Patent Application No. 2,612,940 (Rogers). Another SUP design which enables viscous fluids to be displaced by gravity and/or by pressure applied by squeezing the SUP is disclosed in United States Application 2017/0088388 (Regnier).

The SUP is typically opened at the top of the package, though openings on the side or other locations on the package are also possible. The SUP may be opened with a tear strip; or a fitment (or cap) which allows the package to be re-closed; or other caps/closures, etc. that are known to those skilled in the art. A zip-lock sealing strip may also be incorporated into a SUP, optionally in combination with a tear strip. A mutually peelable seal may also be used at the top of the package.

As previously noted, the conventional PET/PE SUP have a balance of stiffness (or rigidity) and optical properties that are far superior to the properties of conventional “all PE” designs for SUP. It is known to prepare an “all PE” SUP having good rigidity (using HDPE) but the optical properties and stiffness of such packages were poor.

In one embodiment, the present disclosure mitigates this problem by using at least one layer of a lower density polyethylene.

In another embodiment, the stiffness/rigidity and optical properties are improved through the use of a nucleating agent.

In an embodiment of the disclosure, it may be desirable that to look through the coextruded structure to see the contents of a package, such as, for example, a SUP.

Accordingly, it may be desirable for the coextruded structure to have low haze values. In addition, a high “gloss” is desirable as many consumers perceive a high gloss finish as being an indication of high quality.

Also, for application in some embodiments of an SUP, it is generally desirable for the coextruded structure to provide stiffness/rigidity so that an SUP made from the coextruded structure will be self-supporting.

It is known that HDPE provides the desired stiffness but it is also known that HDPE has poor optical properties. Hence, in one embodiment, a very thin layer of HDPE is used in the outer layer and/or the second intermediate layer, while a layer of a lower density polyethylene is used in the first intermediate layer.

Without wishing to be bound by theory, the lower density polyethylene improves the optics of the multilayer structure.

### DESCRIPTION OF EMBODIMENTS

The structure of this disclosure (i.e., the film structure) is prepared by coextrusion, a process well understood by persons skilled in the art.

One embodiment of the present disclosure provides a coextruded multilayer film in which at least two layers are prepared from HDPE and at least one layer residing between the HDPE layers is prepared from a lower density polyethylene such as LLDPE, LDPE, VLDPE or MDPE.

In an embodiment of the present disclosure, a film structure comprises at least four layers: A) a first surface layer; B) a first intermediate layer; C) a second intermediate layer; and D) a second surface layer.

In an embodiment of the present disclosure, the film structure comprises at least four adjacent layers: A) a first surface layer; B) a first intermediate layer adjacent to the first surface layer; C) a second intermediate layer adjacent to the first intermediate layer; and D) a second surface layer adjacent to the second intermediate layer.

It will be recognized by those skilled in the art that this four layer structure may be produced by a film line that contains four extruders and four dies (i.e. one extruder and one die per layer) or more than five extruders/dies (i.e. a “layer” in a four layer structure may actually be made from two adjacent extruders/dies).

In an embodiment of the present disclosure, the film structure comprises at least four adjacent layers: A) a first surface layer which may be considered an outer layer facing the external environment when the structure is made into a package, pouch, container or the like; B) a first intermediate layer adjacent to the first surface layer; C) a second intermediate layer adjacent to the first intermediate layer; and D) a second surface layer adjacent to the second intermediate layer, where the second surface layer may be considered an inner layer facing a sealed interior environment of a package, pouch, container or the like when the structure is made into a package, pouch, container or the like.

In an embodiment of the disclosure, in the coextruded structure, at least one HDPE layer is separated from at least one HDPE layer by a layer of lower density polyethylene, thereby optimizing the rigidity of a package for a given amount of HDPE.

An embodiment of the disclosure is a coextruded structure that is made from polymeric material; the co-extruded structure comprising: A) a first surface layer comprising a HDPE composition; B) a first intermediate layer comprising polyethylene selected from LLDPE and MDPE; C) a second intermediate layer comprising a HDPE composition; and D) a second surface layer comprising a sealable polyethylene composition; wherein the HDPE, MDPE, LLDPE and sealable polyethylene composition collectively form at least 90 weight % of the coextruded structure.

An embodiment of the disclosure is a co-extruded structure that is made from polymeric material; the co-extruded structure comprising: A) a first surface layer comprising an HDPE composition; B) a first intermediate layer comprising MDPE; C) a second intermediate layer comprising an HDPE composition; and D) a second surface layer comprising a sealable polyethylene composition; wherein the HDPE, MDPE and sealable polyethylene composition collectively form at least 90 weight % of the coextruded structure.

In an embodiment of the disclosure, the polymeric materials used in the formation of the coextruded structure consist essentially of different types of polyethylene. Suitable types of polyethylene include: High Density Polyethylene (HDPE), a polyethylene homopolymer or copolymer having a density of from about 0.95 to about 0.97 g/cm³; Medium Density Polyethylene (MDPE), a polyethylene copolymer having a density of from about 0.93 to about 0.95 g/cm³; Linear Low Density Polyethylene (LLDPE), a polyethylene copolymer having a density of from about 0.915 to about 0.93 g/cm³; and a sealable polyethylene composition—a polyethylene sealant material that is suitable for the preparation of a heat formed seal, for example, a polyethylene selected from 1) a polyethylene copolymer having a density of from about 0.88 to 0.915 g/cc (“VLDPE”); and 2) a high pressure low density polyethylene (LDPE)—a polyethylene homopolymer prepared with a free radical initiator in a high pressure process, having a density of from about 0.91 to about 0.93 g/cc, or a polyethylene material that is suitable for the preparation of a peelable seal.

In some embodiments, the coextruded structure of this disclosure is suitable for the preparation of a package for storing food.

In some embodiments, the coextruded structure of this disclosure is suitable for the preparation of a package for storing frozen food.

In some embodiments, the coextruded structure of this disclosure is suitable for the preparation of a Stand Up Pouch (SUP).

In embodiments, the coextruded structure is used to prepare packages for storing food (included frozen food) such as for example an SUP.

In another embodiment, the coextruded structure of the present disclosure is used in lidding applications. Such lidding applications include, for example, using the coextruded structure to form the lid of a tray where the coextruded structure may be heat sealed to a peripheral edge or flange of the tray or package and subsequently removed with a moderate amount of force. Such trays or packages which are well known in the art may be made of for example polyethylene or polypropylene compositions.

In an embodiment, a lid for sealing a package comprising at least one tray area, is prepared from the coextruded structure.

### The First Surface Layer

The first surface layer is an outer layer which faces the environment when the coextruded structure is used in a packaging application.

In an embodiment of the disclosure, the first surface layer comprises an HDPE composition.

HDPE is a common item of commerce. Most commercially available HDPE is prepared from an olefin polymerization catalyst that contains at least one transition metal. Such olefin polymerization catalysts include, for example, those that contain chromium or a group IV transition metal—Ti, Zr or Hf.

HDPE that is made from a Cr catalyst typically contains some long chain branching (LCB). HDPE that is made from a group IV metal may contain less LCB than HDPE made from a Cr catalyst.

As used herein, the term “HDPE” refers to a polyethylene (or polyethylene blend composition, as required by context) having a density of from about 0.95 to 0.97 grams per cubic centimeter (g/cm³).

In an embodiment of the disclosure, the melt index (I₂) of the HDPE is from about 0.1 to 10 grams per 10 minutes (g/10 min). In further embodiments, the HDPE has a melt index, I₂, of from 0.2 to 10 g/10 min, or from 0.3 to 3 g/10 min.

In an embodiment of the disclosure, the HPDE is made using a Ziegler-Natta polymerization catalyst.

In an embodiment, the first surface layer comprises an HPDE which is made using a Ziegler-Natta polymerization catalyst.

In one embodiment, the first surface layer comprises a very thin layer of HDPE.

In an embodiment of the disclosure, the HDPE composition further comprises a nucleating agent.

The term “nucleating” agent, as used herein, is meant to convey its conventional meaning to those skilled in the art of preparing nucleated polyolefin compositions, namely an additive that changes the crystallization behavior of a polymer as the polymer melt is cooled.

A review of nucleating agents is provided in U.S. Pat. Nos. 5,981,636; 6,465,551 and 6,599,971.

Examples of conventional nucleating agents which are commercially available and in widespread use as polypropylene additives are the dibenzylidene sorbital esters (such as, the products sold under the trademark MILLAD® 3988 by Milliken Chemical and IRGACLEAR® by Ciba Specialty Chemicals).

In some embodiments, the nucleating agents should be well dispersed in the polyethylene. In some embodiments, the amount of nucleating agent used is comparatively small—from 200 to 10,000 parts by million per weight (based on the weight of the polyethylene) so it will be appreciated by those skilled in the art that some care must be taken to ensure that the nucleating agent is well dispersed. In some embodiments, the nucleating agent in finely divided form (less than 50 microns, or for example, less than 10 microns) to the polyethylene to facilitate mixing.

Examples of nucleating agents which may be suitable for use in the present disclosure include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophthalic acid structure (or “HHPA” structure) as disclosed in U.S. Pat. No. 6,599,971 (Dotson et al., to Milliken); phosphate esters, such as those disclosed in U.S. Pat. No. 5,342,868 and those sold under the trade names NA-11 and NA-21 by Asahi Denka Kogyo and metal salts of glycerol (for example, zinc glycerolate). The calcium salt of 1,2-cyclohexanedicarboxylic acid, calcium salt (CAS registry number 491589-22-1) may provide good results for the nucleation of HDPE. The nucleating agents described above might be described as “organic” (in the sense that they contain carbon and hydrogen atoms) and to distinguish them from inorganic additives such as talc and zinc oxide. Talc and zinc oxide are commonly added to polyethylene (to provide anti-blocking and acid scavenging, respectively) and they may provide some limited nucleation functionality.

The “organic” nucleating agents described above may be better (but more expensive) nucleating agents than inorganic nucleating agents. In an embodiment, the amount of organic nucleating agent is from 200 to 2,000 parts per million (based on the total weight of the polyethylene in the layer that contains the nucleating agent).

### The First Intermediate Layer

In an embodiment, the first intermediate layer is disposed inwardly of and adjacent to the first surface layer.

In an embodiment, the first intermediate layer is prepared from a polyethylene composition having a lower density than HDPE so as to provide a layer having enhanced impact and tear strength properties in comparison to layers prepared from HDPE.

In an embodiment of the disclosure, the first intermediate layer comprises an LLDPE, an MDPE or an HPDE.

In an embodiment of the disclosure, the first intermediate layer comprises an LLDPE or an MDPE.

In an embodiment of the disclosure, the first intermediate layer comprises LLDPE.

In an embodiment of the disclosure, the first intermediate layer comprises an MPDE.

In an embodiment of the disclosure, the first intermediate layer comprises a VLDPE.

In another embodiment, this first intermediate layer may be prepared with MDPE (or a blend of MDPE with a minor amount of another polyethylene, such as in a blend with LDPE, or in a blend with HDPE and nucleating agent, where the nucleating agent is as described above).

In an embodiment, the LLDPE is further characterized by having a melt index, I₂, of from 0.1 to 5 g/10 min. In another embodiment, the LLDPE has a melt index, I₂ of from 0.3 to 3 grams/10 minutes.

In one embodiment, the very low density polyethylene (VLDPE) is an ethylene copolymer having a density of from about 0.88 to 0.91 g/cc and a melt index, I₂, of from about 0.5 to 10 g/min. All of the materials described above are well known and commercially available.

In an embodiment, the LLDPE is further characterized by being prepared using a single site catalyst (such as a metallocene catalyst) and having a molecular weight distribution, Mw/Mn (i.e., weight average molecular weight divided by number average molecular weight) of from about 2 to about 4. This type of LLDPE may be referred to as sLLDPE.

In another embodiment, the LLDPE used in the first intermediate layer is blended with a minor amount (from 0.2 to 10 weight %) of a low density polyethylene, LDPE having a melt index, I₂, of from 0.2 to 5 g/10 min, or for example from 0.2 to 0.8 g/10 min. Certain blends of LLDPE and LDPE have been observed to have superior optical properties and superior stiffness in comparison to the LLDPE alone (particularly when the LLDPE is as sLLDPE).

In an embodiment, the use of an LDPE resin having a melt index 12 of from about 0.2 to 0.8 grams/10 minutes may be effective for use in the first intermediate layer (and persons skilled in the art commonly refer to this type of LDPE resin as a “fractional melt LDPE”).

In one embodiment, the first intermediate layer is made predominantly from an LLDPE, (including sLLDPE) having a melt index of from 0.3 to 3 grams per 10 minutes.

In another embodiment, the first intermediate layer may be prepared using a major amount of LLDPE (or sLLDPE) and a minor amount of LDPE (for example, a fractional melt LDPE, as described above) or the LLDPE+HDPE+nucleating agent blend as described above.

LLDPE/HDPE/nucleating agent blends have been found to provide superior optical properties and higher modulus (higher stiffness) than 100% LLDPE.

In another embodiment, the LLDPE used is blended with a minor amount (from 0.2 to 10 weight %) of an HDPE resin and a nucleating agent. Suitable nucleating agents are as described above.

In some embodiments, these LLDPE/HDPE/nucleating agent blends have also been found to provide superior optical properties and higher modulus (higher stiffness) than 100% LLDPE.

### The Second Intermediate Layer

In an embodiment, the second intermediate layer is disposed inwardly of and adjacent to the first intermediate layer.

In an embodiment of the disclosure, the second intermediate layer comprises an HDPE composition.

HDPE is a common item of commerce. Most commercially available HDPE is prepared from a catalyst that contains at least metal (for example, chromium or a group IV transition metal—Ti, Zr or Hf).

HDPE that is made from a Cr catalyst typically contains some long chain branching (LCB). HDPE that is made from a group IV metal may contain less LCB than HDPE made from a Cr catalyst.

As used herein, the term “HDPE” refers to a polyethylene (or polyethylene blend composition, as required by context) having a density of from about 0.95 to 0.97 grams per cubic centimeter (g/cc). In an embodiment, the melt index (“I₂”) of the HDPE is from about 0.2 to 10 grams per 10 minutes.

In an embodiment, the HDPE contains one or more than one nucleating agent, where the nucleating agent is described as above.

In an embodiment of the disclosure, the HDPE is as a blend composition comprising two HDPEs (blend component A, and blend component B) having melt indices that are separated by at least a factor of 10. Further details of this HDPE blend composition follow.

In an embodiment of the disclosure, blend component A comprises an HDPE with a comparatively high melt index.

As used herein, the term “melt index” is meant to refer to the value obtained by ASTM D 1238 (when conducted at 190° C., using a 2.16 kg weight). This term is also referenced to herein as “I₂” (expressed in grams of polyethylene which flow during the 10 minute testing period, or “gram/10 minutes”). As will be recognized by those skilled in the art, melt index, I₂, is, in general, inversely proportional to molecular weight. Hence, in one embodiment of the disclosure, blend component A has a comparatively low molecular weight in comparison to blend component B.

In an embodiment of the disclosure, the absolute value of I₂ for blend component A in these HDPE blends is greater than 5 g/10 min. However, the “relative value” of I₂ for blend component A is more important and, in an embodiment of the disclosure, it should be at least 10 times higher than the I₂ value for blend component B. Hence, in the present disclosure, if the I₂ value of blend component B is 1 g/10 min, then the I₂ value of blend component A is, in one embodiment, at least 10 g/10 min.

In an embodiment of the disclosure, blend component A has a density of from 0.95 to 0.97 g/cm³ and is present in an amount of from 5 to 60 weight % of the total HDPE blend composition, with blend component B forming the balance of the total composition. In an embodiment of the disclosure, blend component A has a density of from 0.95 to 0.97 g/cm³ and is present in an amount of from 10 to 40 weight % of the total HDPE blend composition, with blend component B forming the balance of the total composition. In an embodiment of the disclosure, blend component A has a density of from 0.95 to 0.97 g/cm³ and is present in an amount of from 20 to 40 weight % of the total HDPE blend composition, with blend component B forming the balance of the total composition.

In an embodiment of the disclosure, more than one high density polyethylene is used to form blend component A.

The molecular weight distribution—which is determined by dividing the weight average molecular weight (Mw) by number average molecular weight (Mn) where Mw and Mn are determined by gel permeation chromatography, according to ASTM D 6474-99—of blend component A is, for example, 2 to 20, or from 2 to 4.

While not wishing to be bound by theory, it is believed that a low Mw/Mn value (from 2 to 4) for blend component A may improve the crystallization rate and overall barrier performance of coextruded structures prepared in accordance with this disclosure.

In an embodiment of the disclosure, blend component B is also a high density polyethylene which has a density of from 0.95 to 0.97 g/cm³. In another embodiment, blend component B has a density for from 0.955 to 0.968 g/cm³.

The melt index of blend component B is also determined by ASTM D 1238 at 190° C. using a 2.16 kg load.

In an embodiment of the disclosure, the melt index value for blend component B is lower than that of blend component A, indicating that blend component B has a comparatively higher molecular weight.

In an embodiment of the disclosure, blend component B has a melt index, I₂, of from 0.1 to 2 g/10 min.

The molecular weight distribution (Mw/Mn) of blend component B is not critical to the success of this disclosure, but, in an embodiment of the disclosure, blend component B has a Mw/Mn of from 2 to 4.

In an embodiment of the disclosure, the ratio of the melt index of blend component A divided by the melt index of blend component B is greater than 10/1.

In an embodiment of the disclosure, more than one high density polyethylene is used to form blend component B.

The overall high density blend composition is formed by blending together blend component A with blend component B. In embodiments of the disclosure, the HDPE blend composition has a melt index (ASTM D 1238, measured at 190° C. with a 2.16 kg load) of from 0.5 to 10 g/10 min or from 0.8 to 8 g/10 min.

The HDPE blend composition may be made by any blending process, such as: 1) physical blending of particulate resin; 2) co-feed of different HDPE resins to a common extruder; 3) melt mixing (in any conventional polymer mixing apparatus); 4) solution blending; or 5) a polymerization process which employs 2 or more reactors.

A suitable HDPE blend composition may be prepared by melt blending the following two blend components in an extruder from 10 to 30 weight % of blend component A, where blend component A is an HDPE resin having a melt index, I₂, of from 15 to 30 g/10 min and a density of from 0.95 to 0.97 g/cm³ with, from 90 to 70 weight % of blend component B, where blend component B is an HDPE resin having a melt index, I₂, of from 0.8 to 2 g/10 min and a density of from 0.95 to 0.97 g/cm³.

An example of a commercially available HDPE resin which is suitable for blend component A is sold under the trademark SCLAIR® 79F, which is an HDPE resin that is prepared by the homopolymerization of ethylene with a conventional Ziegler-Natta catalyst. In some embodiments, it has a typical melt index of 18 g/10 min and a typical density of 0.963 g/cm³ and a typical molecular weight distribution of about 2.7.

Examples of commercially available HDPE resins which are suitable for blend component B include (with typical melt index and density values shown in brackets): SCLAIR 19G (melt index=1.2 g/10 min, density=0.962 g/cm³); MARFLEX® 9659 (available from Chevron Phillips, melt index=1 g/10 min, density=0.962 g/cm³); and ALATHON® L 5885 (available from Equistar, melt index=0.9 g/10 min, density=0.958 g/cm³).

In an embodiment of the disclosure, the HDPE blend composition is prepared by a solution polymerization process using two reactors that operate under different polymerization conditions. This provides a uniform, in situ blend of the HDPE blend components. An example of this process is described in U.S. Pat. No. 7,737,220.

In an embodiment of the disclosure, the HDPE composition is prepared using only ethylene homopolymers. In this embodiment, this type of composition is especially suitable if it is desired to optimize (maximize) the barrier properties of the structure.

In another embodiment of the disclosure, the HDPE composition may be prepared using copolymers, as this will enable some improvement in the physical properties, for example, impact resistance.

In yet another embodiment of the disclosure, a minor amount (less than 30 weight %) of a lower density polyethylene may be blended into the HDPE blend composition (as again, this can enable some improvement in impact resistance).

In an embodiment of the disclosure, the HDPE blend composition described above is combined with an organic nucleating agent in an amount of from about 300 to 3,000 parts per million by weight, based on the weight of the HDPE blend composition. The use of calcium salt of 1-2 cyciohexane dicarboxylic acid, calcium salt (CAS 491589-22-1) is suitable.

In an embodiment, the HDPE composition used contains a nucleating agent when it is prepared with a group IV transition metal based catalyst (for example Ti).

This type of “nucleated” layer has been observed to provide outstanding barrier properties (i.e., reduced transmission of water, gas and grease), which is desirable for many packaging applications.

In addition, the presence of the nucleating agent has been observed to improve the modulus of the HDPE layer (in comparison to a non-nucleated layer of equivalent thickness).

The use of a nucleated HDPE blend composition of the type described above provides a “barrier” to oxygen and water transmission. The performance of this barrier layer is suitable for many goods. However, it will be recognized by those skilled in the art that improved “barrier” performance can be achieved through the use of certain “barrier” polymers such as ethylene-vinyl-alcohol (EVOH); ionomers and polyamides. The use of large amounts of such non-polyethylene barrier resins can make it very difficult to recycle films/structures/SUP that are made with the combination of polyethylene and non-polyethylene materials. However, it is still possible to recycle such structures if low amounts (less than 10 weight %, or for example less than 5 weight %) of the non-polyethylene materials.

It will also be recognized by those skilled in the art that the use of certain non-polyethylene barrier resins will also require the use of a “tie layer” to allow adhesion between the non-polyethylene barrier layer and the remaining layers of polyethylene.

In an embodiment, the coextruded structure further comprises a barrier layer, wherein the barrier layer is located between the first and second intermediate layers.

In an embodiment, the barrier layer comprises EVOH, with the further proviso that the total weight of the barrier layer is less than 10 weight %, especially less than 5 weight %, based on the combined weight of the EVOH and the total weight of polyethylene used in the structure.

In an embodiment, two tie layers are included in the film structure further comprising a barrier layer, such that a first tie layer is located on one side of the barrier layer and a second tie layer is located on the other side of the barrier layer.

### The Second Surface Layer

The second surface layer is an inner layer which faces the interior of a package when the coextruded structure is used in a packaging application.

In an embodiment, the second surface layer is disposed inwardly of and adjacent to the second intermediate layer.

In an embodiment, the second surface layer comprises a sealable polyethylene composition. A sealable polyethylene composition can be a sealant polyethylene composition or a peelable sealant polyethylene composition.

The second surface layer can be prepared from a “sealant” polyethylene—i.e. a type of polyethylene that readily melts and forms seals when subjected to sealing conditions. Those skilled in the art will recognize that two types of polyethylene are preferred for use as sealants, namely:

1) polyethylene copolymers having a density of from about 0.88 to 0.915 g/cc; and

2) LD polyethylene (as previously described).

The use of lower density polyethylene copolymers is preferred. As a general rule, the cost of these lower density polyethylenes increase as the density decreases, so the “optimum” polyethylene sealant resin will typically be the highest density polyethylene that provides a satisfactory seal strength. A polyethylene having a density of from about 0.900 to 0.912 g/cc will provide satisfactory results for many applications.

Other examples of sealant polyethylenes include ethylene-vinyl acetate (EVA) and “ionomers” (e.g. copolymers of ethylene and an acidic comonomer, with the resulting acid comonomer being neutralized by, for example, sodium, zinc or lithium; ionomers are commercially available under the trademark SURLYN®).

The use of EVA and/or ionomers is less preferred because they can cause difficulties when the SUP is recycled (however, as previously noted, many recycling facilities will accept a SUP that contains up to 5% of EVA or ionomer and recycle the SUP as if it were constructed from 100% polyethylene).

Alternatively, the second surface layer can be prepared from a “peelable sealant” polyethylene composition. A “peelable sealant” polymer is a type of polymer or polymer blend that forms a peelable (i.e. reversible) seal with itself, an adjacent film layer comprising a different polymeric material or with a substrate. In some embodiments, the peelable seal layer can be peeled back and away from itself (as when the coextruded structure in used in a SUP for example), an adjacent film layer or a substrate under ambient temperature conditions. A peelable seal layer may allow rupture of the layer or provide sufficiently low strength so as to promote delamination.

In embodiments of the disclosure, the peelable sealant polyethylene composition is based on a polyethylene selected from LLDPE (including sLLDPE), LDPE and VLDPE.

So called “easy peelable sealants” or “peelable sealants” are well known to persons skilled in the art and include for example polyethylene compositions comprising suitable additives which may be incompatible with the polyethylene matrix. That is, a peelable layer comprising a polyethylene composition may be generated by “poisoning” the layer with an incompatible filler to generate poorly sealed areas or fracture points on or within the peelable seal layer. This allows tearing of a peelable seal layer surface from itself, an adjacent film layer or other substrate material.

Some non-limiting examples for use as fillers or layer poisons include non-polymer substances such as talc, calcium carbonate, and glass beads. Some non-limiting examples for use as fillers or layer poisons also include incompatible polymeric additives such as polybutylene, polymethylpentene, polypropylene, propylene/ethylene copolymers, propylene/ethylene/C₄-C₁₀ alpha olefin terpolymers and blends thereof.

In embodiments of the disclosure, blends of one or more of the above polymeric and/or non-polymeric “fillers” or “poisons” in varying concentrations with a polyethylene composition are used to generate acceptable peel forces, located in the desired areas, to allow clean, lint free peeling.

The use of large amounts of non-polyethylene resins in the peelable seal layer can make it difficult to recycle films/structures/packages that are made with the combination of polyethylene and non-polyethylene materials. However, it is still possible to recycle such structures if low amounts (less than 10 weight %, especially less than 5 weight %) of the non-polyethylene materials are present in the overall film structure.

In some embodiments, a “peelable seal” layer will be a very thin layer, and in some embodiments of the disclosure will have a thickness of from about 0.25 mil to about 0.5 mil, depending on the overall structure thickness and properties required.

In an embodiment, the second surface layer itself comprises at least one layer comprising a sealant polyethylene composition and at least one layer comprising a peelable sealant polyethylene composition.

In an embodiment of the disclosure, the second surface layer is subdivided into at least one layer comprising a sealant polyethylene composition and at least one layer comprising a peelable sealant polyethylene composition.

In an embodiment, the second surface layer comprises two adjacent layers, Da) and Db), wherein Da) is a layer comprising a sealant polyethylene composition (as described above) and Db) is a layer comprising a peelable sealant polyethylene composition (as described above).

In an embodiment, the layer Da) is the second innermost layer in the coextruded structure and the layer Db) is the innermost layer in the coextruded structure, where the innermost layer faces the interior of a package, pouch, sealed tray, container and the like.

In an embodiment, the Da) layer is the second innermost layer in the coextruded structure and is immediately adjacent to the Db) layer which is the innermost layer in the coextruded structure.

In an embodiment, the total thickness of the Da) layer and the Db) layer is about 0.5 mils.

In an embodiment, the thickness of the Da) layer is from about 0.25 mil to about 0.5 mil.

In an embodiment, the thickness of the Db) layer is from about 0.25 mil to about 0.5 mil.

In an embodiment, the seal layer is prepared from a linear low density polyethylene that is prepared suing a construction of a single site catalyst and a heterogeneous catalyst, such as described in U.S. Pat. No. 9,512,282. In an embodiment, the seal layer LLDPE that is made with a single site catalyst and a heterogeneous catalyst has a melt index (I₂) of from 0.5 to 2 g/10 minutes, a density of from 0.90 to 0.92 g/cc and a dilution index (as defined in U.S. Pat. No. 9,512,282) of greater than zero, especially of from 1 to 5.

### Printing Process

The coextruded structure of this disclosure may be surface printed. Suitable processes include the well-known flexographic printing, digital printing and roto gravure printing techniques, which may use nitro cellulose or water based inks. Depending on the inks used and/or coat weights applied, subsequent layers of ink may be applied to ‘build up’ sufficient opacity whether flexographic or gravure printed.

In an embodiment of the disclosure, the printing process involves the application of sufficient quantities of ink to form an opaque printed layer.

In an embodiment of the disclosure, the printing process involves the application of an opaque printed layer.

In an embodiment of the disclosure, the printing process involves the application of at least one printed layer.

In an embodiment of the disclosure, the printing process involves the application of two or more printed layers.

In an embodiment of the disclosure, the coextruded structure is printed with a layer on the surface of the first surface layer. That is, the first surface layer is surface printed with an ink layer.

In an embodiment of the disclosure, the coextruded structure is printed with an opaque layer on the surface of the first surface layer. That is the first surface layer is surface printed with an opaque ink layer or layers.

### Opacifying Agents

In an embodiment of the disclosure, at least one layer of the coextruded structure comprises an opacifying agent.

An opacifying agent is an organic or inorganic substance which when present in a polymer matrix, directly or indirectly reduces light transmission through the matrix. Such a polymer matrix may, for example, be a polymer matrix forming a film layer.

Opacifying agents may in an embodiment of the disclosure be void-initiating solid particles. Such void-initiating solid particles are typically incompatible with the polymer matrix material in which they are present and may occupy less volume than the volume of the void.

Opacifying agents may in an embodiment of the disclosure be solid particles of polybutylene terephthalate (PBT). Particles of PBT may exist as a distributed distinct phase within a polymer matrix or unlike material.

An opacifying agent may, in an embodiment of the disclosure, be a light absorbing pigment.

An opacifying agent may in an embodiment of the disclosure be an inorganic particulate material or filler material (e.g., aluminum powder) as is well known to persons skilled in the art.

In an embodiment, it may be useful to use opacifying agents which reduce the transmission of UV and blue wavelengths of light (e.g. wavelengths of up to 400 nm and from 400 to 450 nm).

Some non-limiting examples of opacifying agents which may be used in the present disclosure include colored pigments, titanium dioxide (TiO₂), talc, iron oxide, carbon black, zinc oxide, and calcium carbonate (CaCO₃).

In an embodiment, at least one layer of the coextruded structure comprises from about 0.5 weight percent to about 15 weight percent of titanium dioxide.

In an embodiment, at least one layer of the coextruded structure comprises from about 1.5 weight percent to about 15 weight percent of titanium dioxide.

In an embodiment, titanium dioxide is added to a polyethylene polymer (e.g. VLDPE, LLDPE, MDPE, HDPE or LDPE) during melt mixing and before extrusion.

In embodiments of the disclosure, any one or more of the layers in the coextruded structure contains an opacifying agent.

In an embodiment of the disclosure, the first surface layer contains an opacifying agent.

In an embodiment of the disclosure, the first intermediate layer contains an opacifying agent.

In an embodiment of the disclosure, the second intermediate layer contains an opacifying agent.

In an embodiment of the disclosure, the first surface layer contains an opacifying agent selected from talc, calcium carbonate, titanium dioxide, zinc oxide and mixtures thereof.

In an embodiment of the disclosure, the first intermediate layer contains an opacifying agent selected from talc, calcium carbonate, titanium dioxide, zinc oxide and mixtures thereof.

In an embodiment of the disclosure, the second intermediate layer contains an opacifying agent selected from talc, calcium carbonate, titanium dioxide, zinc oxide and mixtures thereof.

### Structure Layer Thickness

In an embodiment of the disclosure, the first surface layer has a thickness of from about 0.5 to about 1.0 mils, the first intermediate layer has a thickness of from about 0.5 to about 1.2 mils, the second intermediate layer has a thickness of from about 1.0 to about 2.0 mils, and second surface layer has a thickness of from about 0.25 to about 1.0 mils.

In an embodiment of the disclosure, the first surface layer comprises a HPDE composition and has a thickness of from about 0.5 to about 1.0 mils, the first intermediate layer comprises an MDPE composition and has a thickness of from about 0.5 to about 1.2 mils, the second intermediate layer comprises an HDPE composition and has a thickness of from about 1.0 to about 2.0 mils, and the second surface layer comprises a sealable polyethylene composition and has a thickness of from about 0.25 to about 1.0 mils.

In an embodiment of the disclosure, the first surface layer has a thickness of about 0.75 mils, the first intermediate layer has a thickness of about 0.8 mils, the second intermediate layer has a thickness of about 1.5 mils, and the second surface layer has a thickness of about 0.45 mils.

It will be recognized by those skilled in the art that the above described thickness may be easily modified to change the physical properties of the film structure. For example, the thickness of the HDPE layers may be increased, if it is desired to produce a stiffer SUP, or the thickness of the LLDPE layer(s) may be increased to improve impact resistance. Alternatively, a thicker overall film structure would allow for more separation of the HDPE layers, which would increase stiffness. This may in turn allow a reduction of the thickness of the expensive HDPE layers while still retaining package performance.

In an embodiment of the disclosure, the total thickness of the coextruded structure is from about 2.5 to 7.0 mils, especially from about 3 to about 4 mils.

In an embodiment, a SUP is prepared from the coextruded structure using techniques and machines that are known to those skilled in the art.

In one embodiment, the coextruded structure is sealed using heat seals to form the SUP. In another embodiment, the seals may be formed using ultrasonic sealing.

### EXAMPLES

Test procedures used in the Examples are briefly described below.

Melt Index: “I₂”, was determined according to ASTM D1238. [Note: I₂ measurements are made with a 2.16 kg weight at 190° C.] Test results are reported in units of grams/10 minutes, or alternatively, decigrams/minute (dg/min).

Density was determined using the displacement method according to ASTM D792. Density is reported in grams per cubic centimeters; g/cc or g/cm³.

Gloss was determined by ASTM D2457.

Haze was determined by ASTM D1003.

Film rigidity was measured using a test procedure that is in substantial accordance with ASTM D2923 (“Rigidity of Polyolefin Film and Sheeting”). The test instrument has a sample platform that contains a linear slot. The sample of the film that is to be tested is placed on the platform and a blade is then used to force the film into the slot. The width of the slot is 10 mm. The film sample is 4″×4″ (10.2 cm by 10.2 cm). The results from the test are plotted on a load (in grams) versus extension (in cm) graph. The peak load that is observed during the test (in grams) is divided by the length of the sample (10.16 cm) to produce a “rigidity” value (reported in grams per cm). The test is conducted in both the machine direction (MD) and traverse direction (TD). Rigidity results may be reported as MD; TD; or the average of MD+TD.

The following polyethylene resins were used in the examples (Table 1).

TABLE 1

| | Melt Index, I₂ | Density | |
|---|---|---|---|
| PE Resin Type | (g/10 min) | (g/cm³) | Comonomer |
| ZN-1 | 1 | 0.958 | none |
| ZN-2 | 0.8 | 0.934 | 1-hexene |
| ZN-3 | 0.9 | 0.912 | 1-octene |
| ZN-1 (nuc.) | 1 | 0.958 | none |
| SSC-1 (nuc.) | 1.2 | 0.967 | none |
| SSC-2 | 1 | 0.917 | 1-octene |

The term “ZN” indicates that the polyethylene was prepared with a Ziegler Natta catalyst system. The term “SSC” indicates that the polyethylene was prepared with a single site catalyst system. The term “nuc.” indicates that the resin contains a nucleating agent (aiming point of 1200 parts per million by weight of a commercially available nucleating agent sold under the trademark HYPERFORM® 20E by Milliken Chemicals).

### Rigidity Testing Results

Comparative: Several retail stand up pouches containing foods were purchased at a grocery store. These SUPs were prepared with a conventional PET/PE structure. Film rigidity testing was carried out on a number of films obtained from these retail packages. The film samples each had a thickness of about 3.5 mil. Using the blade/slot apparatus described above, the average rigidity was measured at 5.5 g/cm in both the MD and TD directions. MD rigidity is important because it affects the ability of the SUP to be self-supporting (i.e. to “stand”). It is also important to provide this rigidity with minimum film thickness because down gauged/thinner films use less material. This prior art PET/PE structure has a rigidity/thickness ratio of 5.5 g/cm/3.5 mils (i.e. when “normalized” to a thickness of 1 mil, this corresponds to a rigidity of 1.6 g/cm per mil of thickness in the MD).

Inventive: A 4 layer coextruded film structure was made using a blown film line. The coextruded structure had an overall thickness of 3.5 mils and had the following architecture: ZN-1/ZN-2/SSC-1(nuc.)/ZN-3 (see Table 2).

TABLE 2

| Film Structure Layer | PE Resin Type | Thickness (mils) |
|---|---|---|
| First Surface Layer | ZN-1 | 0.75 |
| First Intermediate Layer | ZN-2 | 0.8 |
| Second Intermediate Layer | SSC-1(nuc.) | 1.5 |
| Second Surface Layer | ZN-3 | 0.45 |

Film rigidity testing was carried out on the structure shown in Table 2 and values of 7.9 g/cm in the MD direction and 6.6 g/cm in the TD were obtained. Thus, the normalized MD rigidity of this coextruded multilayer film structure is 7.9/3.5 or 2.3 g/cm per mil of thickness. This compares very well to the normalized MD rigidity of 1.6 g/cm per mil of thickness that was measured in a PET/PE structure in commercial use in retail packaging. Thus, in an embodiment, the multilayer film (and SUP made from the film) have a normalized MD rigidity of greater than 1.6 g/cm per mil (especially 1.6 to 3 g/cm per mil).

The addition of nucleating agent to the first surface layer (e.g. using ZN-1 (nuc.) in the first surface layer instead of ZN-1) led to further gains in stiffness. The amount of nucleating agent used to prepare ZN-1 was 1200 ppm (of HYPERFORM HPN 20E). For example, when a 1.15 mil film having a two layer structure of ZN-1/ZN-2 was coextruded, the film had both a MD and TD rigidity value of approximately 0.5 g/cm. However, when ZN-1 was nucleated, the same two layer structure (i.e., ZN-1(nuc.)/ZN-2) gave values on the blade/slot test for rigidity of approximately 0.9 g/cm in the MD direction and approximately 1.1 g/cm in the TM direction. The extra stiffness observed with the nucleated ZN-1 in the first surface layer would provide a concomitant increase in the stiffness of the entire 4 layer coextruded structure.

In some prior art SUP made from PE, a large amount of reinforcing filler (such as talc) is used to provide rigidity/stiffness. This can reduce the strength and impact properties of the SUP and, in some cases, can make it difficult to recycle the SUP. Thus, in an embodiment, a preferred SUP of this invention has a rigidity of greater than 1 g/cc per mil of film in the substantial absence of reinforcing filler.

Coextruded Structure with EVOH Barrier Layer

A coextruded multilayer film was prepared with the structure and materials shown in Table 3.

TABLE 3

| Layer | 1 | 2 | 3 | 4 | 5 | 6 | 7 | 8 | 9 |
|---|---|---|---|---|---|---|---|---|---|
| Amount | 12.8% | 14.8% | 5.0% | 3.4% | 5.0% | 14.8% | 11.4% | 11.4% | 21.4% |
| Material | ZN-3 | SCC-1 | (80)% + SSC-1 | EVOH | (80)% + SSC-1 | SSC-1 | ZN-2 | ZN-2 | ZN-1 |
| | | | (20)% T-1 | | (20)% T-1 | | | | |

Notes:
1. Layer 1 contained the following conventional additives: a) polymer process and, or PPA (a fluoroelastomer, used to reduce “melt fracture” in blown film extrusion); particulate antiblock (silica, used to reduce the tendency of layers of roll stock from sticking together); slip (a fatty amide, also used to reduce sticking between layers).
2. Layer 9 also contained PPA to mitigate melt fracture.
3. EVOH is an ethylene - vinyl alcohol barrier resin sold under the tradename EVAL F171B by Kurary and reported to contain 44 mole % ethylene and has a melting point of 165° C.
4. T-1 is a “tie-layer concentrate” used to improve the adhesion between the EVOH and PE layers. It is sold under the tradename BYNEL 41E710 and is reported (by the supplier, DuPont) to be a maleic-anhydride modified polyolefin.
5. Layers 3 and 5 contain a blend of SSC-1 (80 weight %) and T-1 (20 weight %).

### Water Vapor Transmission Rate (WVTR)

Water Vapor Transmission Rate (WVTR), expressed as grams of water vapor transmitted per 100 square inches of film per day at a specified film thickness (mils), or g/100 in²/day) was measured in accordance with ASTM F1249-90 with a MOCON® Permatron available from Modern Controls Inc. at conditions of 100° F. (37.8° C.) and 100% relative humidity. The WVTR test was run in duplicate and the average WVTR was reported.

### Oxygen Transmission Rate (OTR)

Oxygen transmission rate (OTR), expressed as cm³ of oxygen transmitted per 100 square inches of film per day at a specified film thickness (mils), or cm³/100 in²/day) was measured on film samples (4 inch×4 inch) at 0% relative humidity and 23° C. using MOCON OX-TRAN® System Model 2/21T. The OTR test was run in duplicate and the average rate of oxygen permeation was determined at an equilibrium state.

WVTR was found to be 0.043 g/100 in² per day when determined at 37.8° C. and 100% relative humidity. OTR was found to be 0.121 cc/100 in² per day at 23° C. and 0% relative humidity.

### Manufacture of Stand Up Pouches

This example illustrates the preparation of Stand Up Pouches according to this invention. The SUP were made on a machine manufactured by Effytec Packaging, a division of Eficiencia Y Technologia, S.A. of Barcelona, Spain.

A coextruded multilayer film having the structure described in Table 3 was used. It was supplied as a roll of film (‘roll stock’).

The SUP machine was designed to be used with typical (prior art) PE/PET laminates. The machine had three sealing actions and operates at a rate of up to 60 packages per minute. Roll stock having the formulation shown in Table 3 was successfully used at commercial operating rates and SUP packages of good quality were produced.

As shown in Table 3, the roll stock used in this example contained a 1.5 mil thick layer of nucleated HDPE. It is believed that this layer is important for the “processability” of the roll stock on the SUP machine. It will be appreciated by those skilled in the art that attempts to use an “all PE” roll stock that is made without nucleated HDPE on a conventional SUP machine (i.e. a machine designed to be used with PET/PE roll stock) are typically not successful—it is believed that the poor processability of (conventional) “all PE” roll stock is a result of poor rigidity/stiffness. The lack of stiffness causes poor “registration” (i.e. the film stretches so that it is not properly aligned in the machine). Thus, high stiffness is helpful for “processability” as well as for providing the ability of the SUP to “stand up.”

### INDUSTRIAL APPLICABILITY

A coextruded structure made of different types of (specified) polyethylene has a surprisingly high stiffness that enables the use of the coextruded structure in the manufacture a Stand Up Pouch (SUP). Prior art SUP packages are typically made from a coextruded structure of polyethylene terephthalate (PET) and polyethylene, which provides good stiffness, but the use of the PET and polyethylene in the coextruded film makes the prior art packages difficult to recycle. The present SUP packages are recyclable and are suitable for the packaging of a wide variety of consumer goods, especially foods

1. A coextruded multilayer film that is suitable for the preparation of a stand up pouch, comprising:
A) a first surface layer comprising a HDPE composition;
B) a first intermediate layer comprising a polyethylene selected from LLDPE and MDPE;
C) a second intermediate layer comprising a HDPE composition; and
D) a second surface layer comprising a sealable polyethylene composition,
wherein the HDPE, MDPE, LLDPE and sealable polyethylene composition collectively form at least 90 weight % of said coextruded multilayer film.

2. The coextruded multilayer film of claim 1 and said second intermediate layer comprises an HDPE composition comprising a nucleating agent.

3. The coextruded multilayer film of claim 2 wherein said HDPE composition of said second intermediate layer comprises an HDPE blend, the HDPE blend comprising a blend component A and a blend component B, wherein the blend component A has a melt index, I₂ which is at least 10 times higher than the melt index, I₂ of blend component B.

4. The coextruded multilayer film of claim 3 having a total thickness of from 2.5 to 7.0 mils and a normalized machine direction rigidity of greater than 1.5 g/cm per mil.

5. The coextruded multilayer film of claim 1 wherein said multilayer film further comprises a barrier layer, wherein the barrier layer is located between the first and second intermediate layers.

6. The coextruded multilayer film of claim 5 wherein the barrier layer comprises EVOH, with the further proviso that the total weight of the barrier layer is less than weight %, based on the combined weight of the EVOH and the total weight of polyethylene used in the coextruded structure.

7. The coextruded multilayer film of claim 1 wherein said first surface layer comprises an HDPE composition containing a nucleating agent.

8. A stand up pouch prepared from a coextruded multilayer film, said coextruded multilayer film comprising:
A) a first surface layer comprising a HDPE composition;
B) a first intermediate layer comprising a polyethylene selected from LLDPE and MDPE;
C) a second intermediate layer comprising a HDPE composition; and
D) a second surface layer comprising a sealable polyethylene composition,
wherein the HDPE, MDPE, LLDPE and sealable polyethylene composition collectively form at least 90 weight % of said coextruded multilayer film.

9. The stand up pouch of claim 8 wherein said first surface layer comprises an HDPE composition containing a nucleating agent and said second intermediate layer comprises an HDPE composition comprising a nucleating agent.

10. The stand up pouch of claim 8 wherein said HDPE composition of said second intermediate layer comprises an HDPE blend, the HDPE blend comprising a blend component A and a blend component B, wherein the blend component A has a melt index, I₂ which is at least 10 times higher than the melt index, I₂ of blend component B.

11. The stand up pouch of claim 10 having a total thickness of from 2.5 to 7.0 mils and a normalized machine direction rigidity of greater than 1.5 g/cm per mil.

12. The stand up pouch of claim 8 wherein the said multilayer film further comprises a barrier layer, wherein the barrier layer is located between the first and second intermediate layers.

13. The stand up pouch of claim 12 wherein the barrier layer comprises EVOH, with the further proviso that the total weight of the barrier layer is less than 10 weight %, based on the combined weight of the EVOH and the total weight of polyethylene used in the coextruded structure.

14. The stand up pouch of claim 9 wherein said first surface layer comprises an HDPE composition comprising a nucleating agent.
